(19) United States
(12) Patent Application Publication
(10) Pub. No.: US 2017/0132806 A1
(43) Pub. Date: May 11, 2017

(54) SYSTEM AND METHOD FOR AUGMENTED REALITY AND VIRTUAL REALITY APPLICATIONS

(71) Applicant: SULON TECHNOLOGIES INC., Markham, CA (US)

(72) Inventor: Dhanushan BALACHANDRESWARAN, Richmond Hill (CA)

(21) Appl. No.: 15/240,609

(22) Filed: Aug. 18, 2016

Related U.S. Application Data
(63) Continuation of application No. PCT/CA2015/050123, filed on Feb. 18, 2015.
(60) Provisional application No. 61/941,078, filed on Feb. 18, 2014.

(51) Int. Cl. G06T 7/73; G06K 9/62; G06T 7/55; G06T 19/00; H04N 13/02

(52) U.S. Cl. CPC G06T 7/74; G06T 19/006; H04N 13/0271; G06T 7/55; G06K 9/623; G06T 2207/30208

(57) ABSTRACT

A multi dynamic environment and location based active augmented reality (AR) system is described. Scanning and imaging are performed by an HMD worn by a user in the physical environment. Described herein are systems and methods of imaging an environment with an imaging system, wherein the imaging system takes images of the environment from its field of view, a processor detects or selects a marker in the environment from the images, and the processor determines or tracks the HMD's position and orientation by processing images of the marker.

### TECHNICAL FIELD

The following relates to systems and methods for imaging a physical environment for augmented reality and virtual reality applications.

### BACKGROUND

Augmented reality (AR) and virtual reality (VR) visualisation applications are increasingly popular. The range of applications for AR and VR visualisation has increased with the advent of wearable technologies and 3-dimensional (3D) rendering techniques. AR and VR exist on a continuum of mixed reality visualisation.

### SUMMARY

In one aspect, a system for determining the position and orientation of a head mounted display (HMD) for augmented and virtual reality applications is provided, the system comprising: (a) a camera system coupled to the HMD comprising at least one camera for obtaining images in a field of view of the camera system; (b) at least one marker positioned within the field of view of the camera system; (c) a processor in communication the camera system, the processor configured to: (i) obtain at least one characteristic of the at least one marker, the at least one characteristic corresponding to at least a two dimensional representation of the marker; (ii) obtain the image from the camera system; (iii) detect at least one marker within the image; (iv) upon a marker being detected, determine the position and orientation of the at least one marker relative to the camera system by comparing the orientation of the marker in the image with the at least one characteristic; (v) perform a reverse transformation on the at least one marker's determined position and orientation to determine the position and orientation of the HMD.

In another aspect, a system for determining the position and orientation of a head mounted display (HMD) for augmented and virtual reality applications is provided, the system comprising: (a) a camera system coupled to the HMD comprising at least one camera for obtaining images in a field of view of the camera system; (b) a processor in communication the camera system, the processor configured to: (i) obtain, by the camera system, a plurality of images in the field of view of the camera system during movement of the HMD; (ii) define at least one marker common to at least two of the plurality of images; (iii) determine at least one characteristic of the marker corresponding to at least a two dimensional representation of the marker; (iv) determine the position and orientation of the at least one marker relative to the camera system by comparing the orientation of the marker in a first one of the images with the orientation of the marker in a second one of images based upon a transformation of the at least one characteristic; and (v) perform a reverse transformation on the at least one marker's determined position and orientation to determine the position and orientation of the HMD.

In a further aspect, a method for determining the position and orientation of a head mounted display (HMD) for augmented and virtual reality applications is provided, the method comprising: (a) obtaining images in a field of view of the camera system coupled to the HMD, at least one of the images capturing at least one marker; (b) obtaining at least one characteristic of the at least one marker, the at least one characteristic corresponding to at least a two dimensional representation of the marker; (c) detecting at least one marker within the image; (d) determining the position and orientation of the at least one marker relative to the camera system by comparing the orientation of the marker in the image with the at least one characteristic; and (e) performing a reverse transformation on the at least one marker's determined position and orientation to determine the position and orientation of the HMD.

In yet another aspect, a method for determining the position and orientation of a head mounted display (HMD) for augmented and virtual reality applications, the method comprising: (a) obtaining, by camera system coupled to the HMD, a plurality of images in the field of view of the camera system during movement of the HMD; (b) defining at least one marker common to at least two of the plurality of images; (c) determining at least one characteristic of the marker corresponding to at least a two dimensional representation of the marker; (d) determining the position and orientation of the at least one marker relative to the camera system by comparing the orientation of the marker in a first one of the images with the orientation of the marker in a second one of images based upon a transformation of the at least one characteristic; and (e) performing a reverse transformation on the at least one marker's determined position and orientation to determine the position and orientation of the HMD.

These and other embodiments are contemplated.

These and other embodiments are described herein in greater detail.

### BRIEF DESCRIPTION OF THE DRAWINGS

A greater understanding of the embodiments will be had with reference to the Figures, in which:

FIG. 1 is a view of a head mounted display for use with an imaging system or method for tracking a user;

FIG. 2 is an illustration of a prior art system of tracking a user of a head mounted display;

FIG. 3 is a side view of an embodiment of a system for imaging a physical environment;

FIG. 4 is a side view of embodiments of a camera system for a system of imaging a physical environment;

FIG. 5 is a flowchart illustrating a method of imaging a physical environment, the method comprising selecting a static marker;

FIG. 6 is an illustration of a step of a method of imaging a physical environment;

FIG. 7 is an illustration of a further step of a method of imaging a physical environment;

FIG. 8 is an illustration of a further step of a method of imaging a physical environment;

FIG. 9A is a front view of a tracking marker module for use in systems and methods of imaging a physical environment;

FIG. 9B is a view of a tracking marker module for use in systems and methods of imaging a physical environment

FIG. 9C is a top view of a system for imaging a physical environment;

FIG. 9D is a further top view of a system for imaging a physical environment;

FIG. 10 is a flowchart illustrating a method of tracking changes to the position and orientation of an HMD.

FIG. 11A is a flowchart illustrating a step of a method of tracking changes to the position and orientation of an HMD;

FIG. 11B is a flowchart illustrating a further step of a method of tracking changes to the position and orientation of an HMD;

FIG. 12A is a flowchart illustrating a further step of a method of tracking changes to the position and orientation of an HMD;

FIG. 12B is a flowchart illustrating a further step of a method of tracking changes to the position and orientation of an HMD;

FIG. 13A is a flowchart illustrating a further step of a method of tracking changes to the position and orientation of an HMD;

FIG. 13B is a flowchart illustrating a further step of a method of tracking changes to the position and orientation of an HMD; and

FIG. 14 is a flowchart illustrating a method of dynamically selecting a marker according to a hierarchy of markers.

### DETAILED DESCRIPTION

It will be appreciated that for simplicity and clarity of illustration, where considered appropriate, reference numerals may be repeated among the Figures to indicate corresponding or analogous elements. In addition, numerous specific details are set forth in order to provide a thorough understanding of the embodiments described herein. However, it will be understood by those of ordinary skill in the art that the embodiments described herein may be practised without these specific details. In other instances, well-known methods, procedures and components have not been described in detail so as not to obscure the embodiments described herein. Also, the description is not to be considered as limiting the scope of the embodiments described herein.

It will be appreciated that various terms used throughout the present description may be read and understood as follows, unless the context indicates otherwise: “or” as used throughout is inclusive, as though written “and/or”; singular articles and pronouns as used throughout include their plural forms, and vice versa; similarly, gendered pronouns include their counterpart pronouns so that pronouns should not be understood as limiting anything described herein to use, implementation, performance, etc. by a single gender. Further definitions for terms may be set out herein; these may apply to prior and subsequent instances of those terms, as will be understood from a reading of the present description.

It will be appreciated that any module, unit, component, server, computer, terminal or device exemplified herein that executes instructions may include or otherwise have access to computer readable media such as storage media, computer storage media, or data storage devices (removable and/or non-removable) such as, for example, magnetic discs, optical discs, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile discs (DVD) or other optical storage, magnetic cassettes, magnetic tape, magnetic disc storage or other magnetic storage devices, or any other medium which can be used to store the desired information and which can be accessed by an application, module, or both. Any such computer storage media may be part of the device or accessible or connectable thereto. Further, unless the context clearly indicates otherwise, any processor or controller set out herein may be implemented as a singular processor or as a plurality of processors. The plurality of processors may be arrayed or distributed, and any processing function referred to herein may be carried out by one or by a plurality of processors, even though a single processor may be exemplified. Any method, application or module herein described may be implemented using computer readable/executable instructions that may be stored or otherwise held by such computer readable media and executed by the one or more processors.

The present disclosure is directed to systems and methods for augmented reality (AR). However, the term “AR” as used herein may encompass several meanings. In the present disclosure, AR includes: the interaction by a user with real physical objects and structures along with virtual objects and structures overlaid thereon; and the interaction by a user with a fully virtual set of objects and structures that are generated to include renderings of physical objects and structures and that may comply with scaled versions of physical environments to which virtual objects and structures are applied, which may alternatively be referred to as an “enhanced virtual reality”. Further, the virtual objects and structures could be dispensed with altogether, and the AR system may display to the user a version of the physical environment which solely comprises an image stream of the physical environment. Finally, a skilled reader will also appreciate that by discarding aspects of the physical environment, the systems and methods presented herein are also applicable to virtual reality (VR) applications, which may be understood as “pure” VR. For the reader's convenience, the following may refer to “AR” but is understood to include all of the foregoing and other variations recognized by the skilled reader.

The singular “processor” is used herein, but it will be appreciated that the processor may be distributed amongst the components occupying the physical environment, within the physical environment or in a server in network communication with a network accessible from the physical environment. For example, the processor may be distributed between one or more head mounted displays and a console located within the physical environment, or over the Internet via a network accessible from the physical environment.

As a user equipped with a head mounted display moves through a physical environment wearing a head mounted display (HMD) for augmented reality and virtual reality applications, a processor linked to the HMD may determine the user's position and orientation relative to the environment in order to ensure that a virtual image stream accurately represents the user's position and orientation within the physical environment.

In embodiments, in order to determine a relative position and orientation of an HMD (and its associated user) with respect to a marker, a processor obtains images of the physical environment from an imaging system comprising an image capture device, such as, for example a camera. A processor in communication with the HMD processes the images to detect a tracking marker module, wherein the tracking marker module is a type of marker having known features. The processor is configured to process an image of the tracking marker module to determine the relative position and orientation of the tracking marker module relative to the HMD, and the processor is further configured to determine the HMD's own position and orientation by performing a transformation of the tracking marker module's relative position and orientation.

In embodiments, in order to determine changes to the position and orientation of an HMD (and its associated user) as the HMD moves through a physical environment, a processor obtains images of the environment from an imaging system. The processor detects a tracking marker module or dynamically selects a marker from within the images. Once a marker is detected or selected, the processor may store a reference image of the marker to memory. As the user continues to move through the environment, the user's position and orientation can be inversely determined based on changes to the way the imaging system perceives the marker. Specifically, the processor is configured to process changes to rendered features of the marker in the images over time to determine therefrom changes to the position and orientation of the HMD.

In embodiments, the processor may continuously process images from the imaging system to detect at least one marker. In some embodiments, if no marker is detected, the processor may dynamically select a most preferred marker according to a hierarchy of candidate markers. The hierarchy may be stored in a memory accessible by the processor. Once a marker is dynamically selected, it may be used for tracking changes to the relative position and orientation of the HMD therefrom.

As a user continues to move or turn, a marker may no longer be detected in the image stream. If no marker is detected, and another marker cannot be or is not dynamically selected, the processor may obtain orientation measurements from an inertial measurement unit to determine an expected current position and orientation of the HMD.

In some embodiments, the processor identifies at least two markers in the environment at any given time, such that the processor can determine changes to the position and orientation of the HMD based on a comparison of images of the second marker once the first marker is no longer within the field of view of an imaging system.

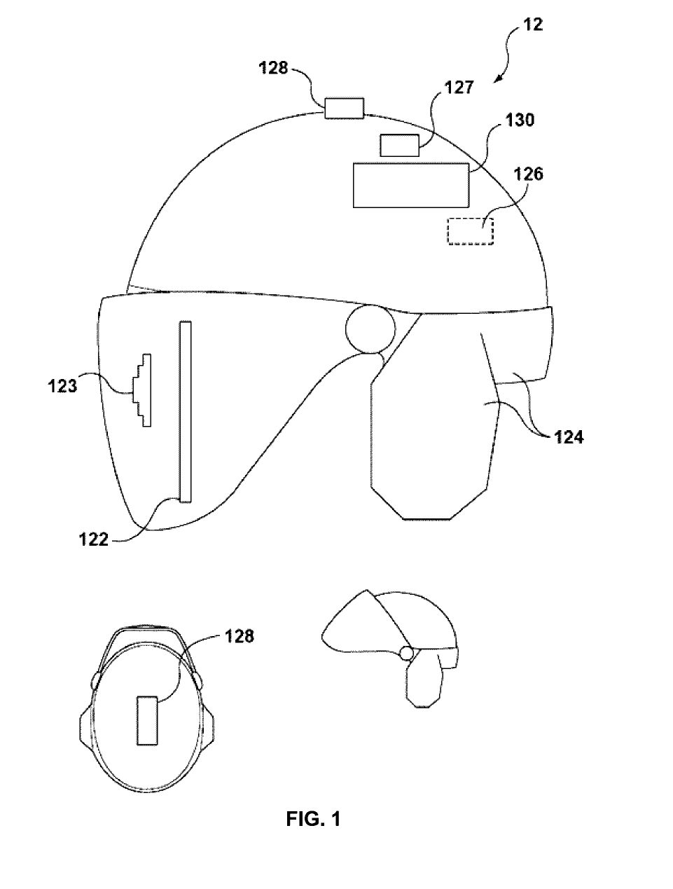

Referring now to FIG. 1, an exemplary HMD 12 configured as a helmet is shown; however, other configurations are contemplated. The HMD 12 may comprise: a processor 130 in communication with one or more of the following components: (i) a scanning, local positioning and orientation module (“SLO”) 128 comprising a scanning system for scanning the physical environment, a local positioning system (“LPS”) for determining the HMD 12's position within the physical environment, and an orientation detection system for detecting the orientation of the HMD 12 (such as an inertia measuring unit “IMU” 127); (ii) an imaging system (“IMS”), such as, for example, a camera system comprising one or more cameras 123, to capture image streams of the physical environment; (iii) a display 122 for displaying to a user of the HMD 12 the AR and the image stream of the physical environment; (iv) a power management system (not shown) for distributing power to the components; and (v) an audio system 124 with audio input and output to provide audio interaction. The processor 130 may further comprise a wireless communication system 126 having, for example, antennae, to communicate with other components in an AR system, such as, for example, other HMDs, a gaming console, a router, or at least one peripheral to enhance user engagement with the AR.

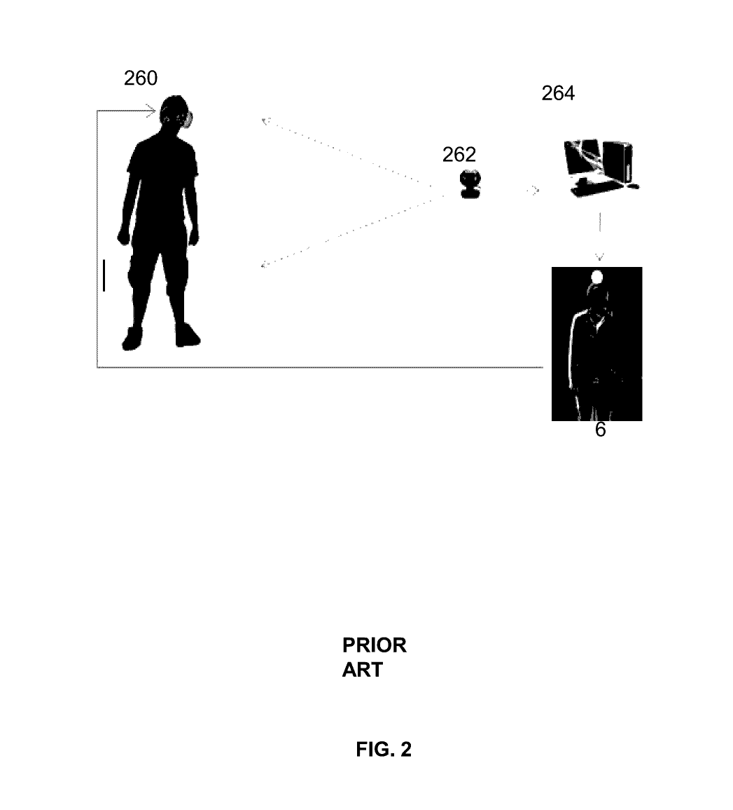

Referring now to FIG. 2, shown therein is an illustration of a traditional method of tracking the position of a user 260 within the physical environment. As illustrated, a camera 262 may be positioned externally to the user 260 for tracking the user's movement, in what is referred to as “outside-in” tracking. The user may be provided with wearable technology to facilitate tracking by the external camera. In use, in order to track the user, the camera 262 provides images of the user 260 to a processing unit 264 which generates a skeleton model 266 to obtain a rough boundary of the user. Additionally, for visual illustration, a circle may be placed above the user's head in a graphical user interface indicating orientation of the user's head for head tracking, or merely that head tracking is active.

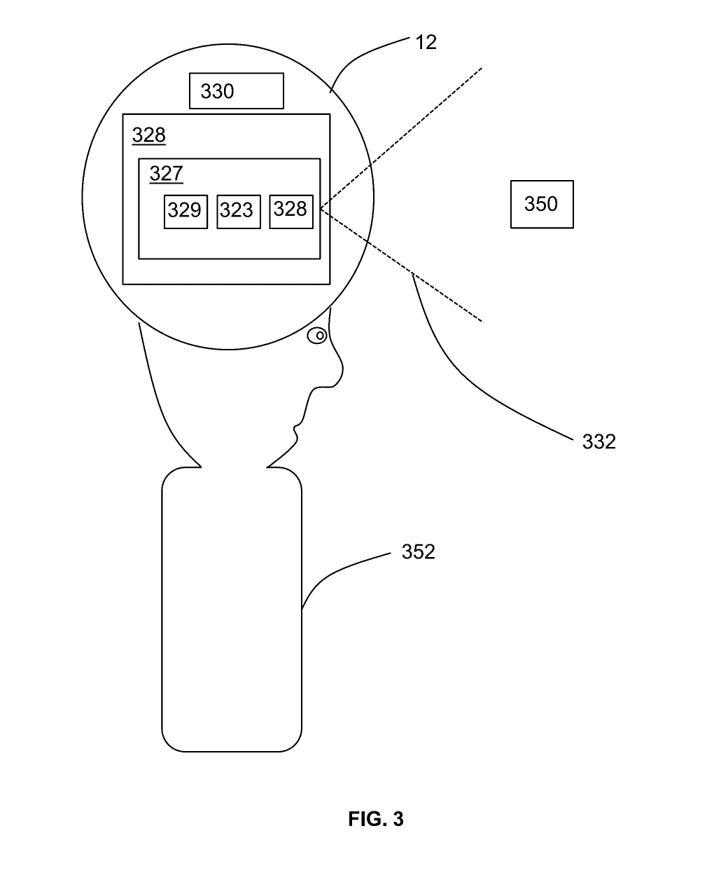

Referring now to FIG. 3, shown therein is an illustrative embodiment of an HMD 12 comprising an imaging system (“IMS”) 328 configured to track the position and orientation of an HMD 12 by processing changes to at least one marker, such as a tracking marker module 350, between subsequent images in a series of images comprising the marker.

In embodiments, and as described in more detail below, the IMS 328 of the present invention may be configured to determine its position and orientation in a physical environment if a tracking marker module 350 having known characteristics is within its field of view. More particularly, IMS 328 may be configured to receive an image from the camera system 327 and to send the image to a processor 330 for processing. The image records the environment within the field of view 332 of the camera system 327. If upon processing the image, the processor 330 detects a tracking marker module 350 having known characteristics, the processor may determine the position and orientation of the IMS 328 (and any associated user 352 or HMD 12) in the physical environment relative to the tracking marker module 350, for use in generating a physical or virtual image stream. Specifically, the processor 330 may be configured to process an image of the at least one tracking marker module 350 to determine the orientation and a position of the HMD comprising the IMS 328 relative to the marker.

In embodiments, and as described in more detail below, the IMS 328 of the present invention is further configured to track changes to its position and orientation in a physical environment by processing changes between subsequent images of at least one detected or dynamically selected marker. More particularly, at an initial time t=0, IMS 328 may provide images of the field of view 332 of a camera system 327 to a processor 330 for processing. Upon processing the images, the processor 330 detects a known tracking marker module 350 or dynamically selects at least one marker. The processor may store a reference image of the detected or selected marker in its memory. At a later time t=1, the IMS 328 provides additional images of the field of view 332 of the camera system 327 to the processor for processing. If the processor 330 detects the previously detected or dynamically selected marker, the processor may be configured to determine a change to the relative position and orientation of the IMS 328 (and any associated user 352 or HMD 12) between t=0 and t=1. Specifically, the processor 330 may be configured to process changes between a feature set of the marker in a new image taken at t=1, and a feature set in the stored reference image of the marker taken at t=0, in order to determine changes to the orientation and position of the HMD between the initial time t=0 and later time t=1.

According to various embodiments, additionally to determining changes to the position and orientation of the HMD by processing images from the IMS 328, the processor may determine changes to the HMD's position and orientation by processing information provided by an inertial measurement unit (IMU). The IMU may comprise a gyroscope or an accelerometer, or other sensors for determining changes to the HMD's orientation. In various embodiments, position and orientation information from the IMU may be combined with the determinations of the HMD's position and orientation made with respect to images from the IMS in order to enhance accuracy of any determined position and orientation.

The IMS 328 of the present invention thus comprises a camera system 327 for providing an image stream comprising images of the physical environment captured within the field of view 332 of the camera system 327. Referring now to FIG. 3, shown therein is a side view of various embodiments and components of the camera system 327 for use in the IMS of the present invention. The camera system 327 may comprise various types of cameras. The camera system 327 may comprise one or more depth cameras 329 (e.g., a time-of-flight camera) to capture depth information for a physical environment, one or more imaging cameras 323 to capture a physical image stream of the physical environment, and one or more infrared camera 328 to capture an infrared image stream of the physical environment.

An imaging camera 323 may comprise a CMOS or a CCD camera. A depth camera 329 may comprise a time of flight (infrared light) camera or a structured light camera, and may be configured to provide signals to a processor 330 for generating a depth map of the physical environment. An infrared camera 328 may comprise a time of flight camera or a structured light camera. Any of the types of camera may be connected via wireless or wired connection to the processor 330 or components of the HMD 12 in order to be integrated with the HMD and be communicatively linked with the processor 330.

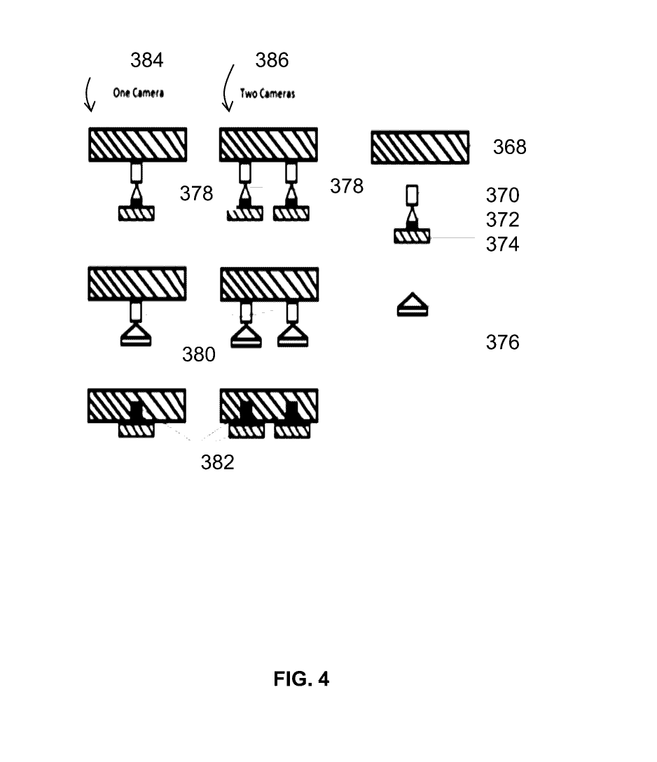

FIG. 4 illustrates various components and embodiments of the camera system 327. As illustrated, each camera comprises an image capturing device 370. Each image capturing device 370 may be mounted adjacent to a camera mounting 368 as shown by cameras 378 and 380, or may be embedded within an external layer of the camera mounting 368 as illustrated by elements 382. In some embodiments, the processor 330 is located adjacent the image capturing device 370 within the camera mounting 368. Each camera may be provided with an external lens for increased clarity or field of view, such as a lens 372 or a wide field of view lens 376 as shown by cameras 380. A demagnification lens 374 may be provided, and any included lenses may be autofocusing (AF) 378. Further, selected cameras may be a full frame (FF) camera. Cameras may be selected to have specifications such as high resolution and high rendering capabilities.

As illustrated in the embodiments of the camera system 327 illustrated in FIG. 4, each camera system may comprise more than a single camera. According to various embodiments, each camera system 327 may comprise a single camera as represented by the embodiments illustrated by element 384 or two cameras as by the element 386, respectively for providing single or stereo vision of the environment.

Referring again to FIG. 3, the IMS may be configured to capture images of a marker within the physical environment. Generally, the marker provides at least one reference point captured by the imaging system such that the processor may determine changes to the relative position and orientation of the HMD relative to marker, as described in more detail below.

Various embodiments of the marker are contemplated. The markers provide 2D or 3D structure. Markers may comprise, for example, active markers, including light markers or IR markers, or passive markers, including 2D or 3D objects. In embodiments, active markers and passive markers may be detected using embodiments of the camera system comprising an imaging camera. Infrared markers may be detected using embodiments where the IMS comprises an infrared camera.

Active markers may comprise a single colour light, multi-colour light, flashing colours or character displays. More specifically, active light markers may comprise light emitting diodes.

In some embodiments, the marker comprises an infrared marker, i.e., a marker that can be detected by an infrared camera. In some embodiments comprising an infrared marker, an infrared retro-reflective marker is used as a marker. Other types of infrared markers are contemplated. The active marker provides 2D or 3D structure to be captured by the camera system.

In some embodiments, the marker comprises a passive 2D or 3D object. 2D markers may comprise, for example, images printed onto paper. 3D markers may include any physical 3D object, as described in more detail below.

In various embodiments, the multiple types of markers may be imaged. It will be appreciated that an appropriate type of marker will be selected depending on the type of camera selected. By way of example, in an embodiment wherein the camera system comprises an infrared camera and an imaging camera, at least an infrared marker and an active light marker may be included.

In embodiments, the marker comprises a tracking marker module 350, for which features are known. In an embodiment, the tracking marker module 350 may be detected and imaged in order to determine the relative position and orientation of the camera system (and associated HMD).

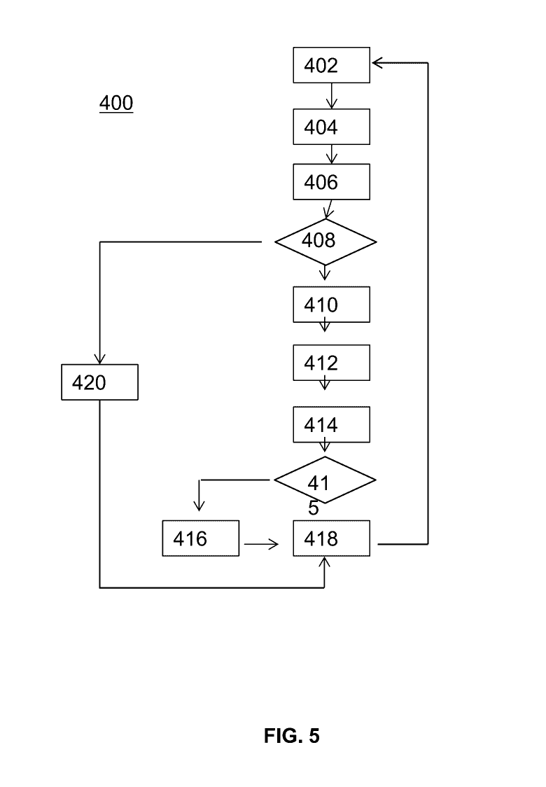

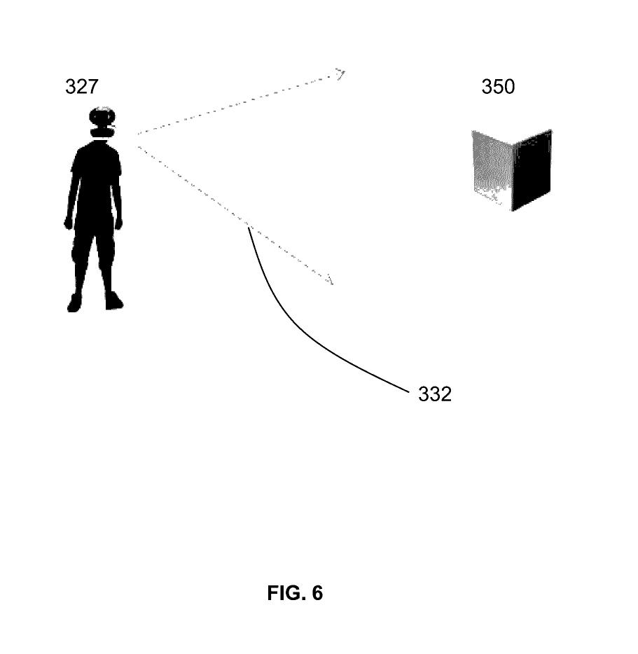

Referring now to FIG. 5, shown therein is a flowchart illustrating blocks 400 of a method of using the IMS 328 of the present invention for determining the position of an HMD 12 in conjunction with a tracking marker module 350 having known features. Further, FIGS. 6 to 9B illustrate aspects of the steps performed in relation to the blocks of FIG. 5.

At block 402, a camera system 327 of an IMS is activated by instructions from a processor 330 and is controlled to generate an image depicting its field of view 332. At block 404, the camera system 327 provides sensor readings depicting an image of its field of view to the processor 330. At block 406, the processor processes the sensor readings in conjunction with instructions for detecting a tracking marker module 350. At block 408, if the processor detects at least one tracking marker module 350 in the sensor readings, the processor proceeds to execute steps relating to block 410. If at block 408, the processor does not detect sensor readings providing a depiction of a tracking marker module 350, the processor proceeds to execute steps relating to block 420 described below. At block 410, the processor processes the particular sensor readings relating to the detected tracking marker module and determines the marker's position and orientation relative to the HMD therefrom. This can be accomplished by obtaining a characteristic of the marker that indicates the 2D or 3D structure of the marker.

At block 412, the processor 330 may send the marker's position and orientation to a graphics engine (not shown) as an input. At block 414, the processor performs a reverse transformation on the marker's position and orientation relative to the HMD in order to determine the HMD's position and orientation. At block 415, if the processor detects that an IMU is connected to the processor, the method proceeds to block 416. If no IMU is connected the method proceeds to step 418. At block 418, the processor may further process any determined position and orientation. Specifically, the position and orientation may be sent to the graphics engine as an input, or to the HMD display for use in various AR applications. As illustrated, the steps depicted in the blocks 402 to 418 may then be repeated, wherein each time the blocks 400 are performed is referred to as a single scan or imaging.

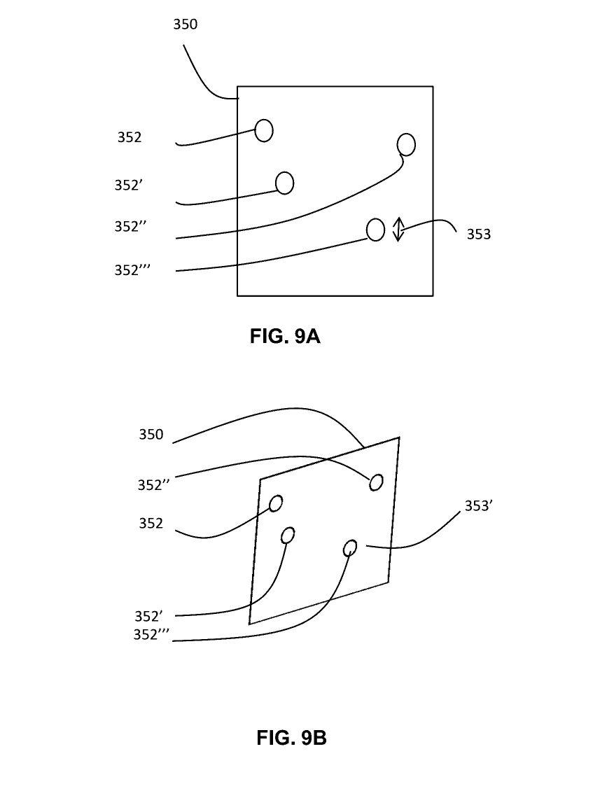

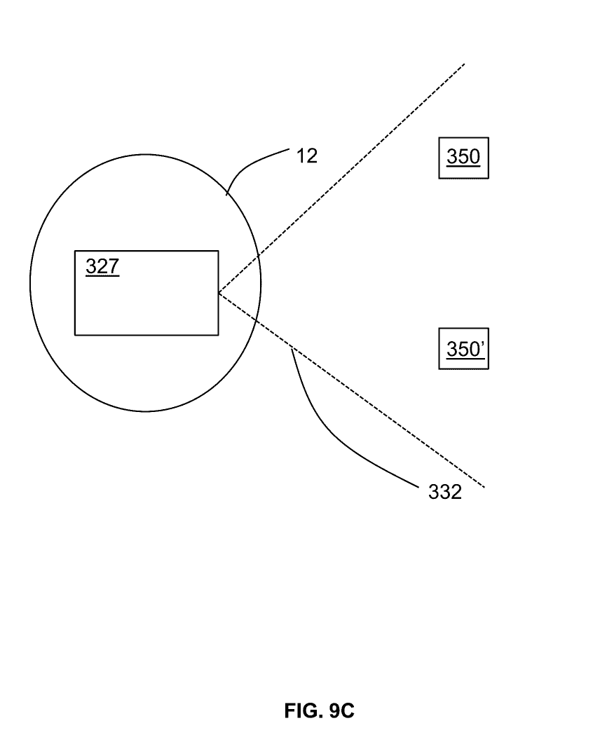

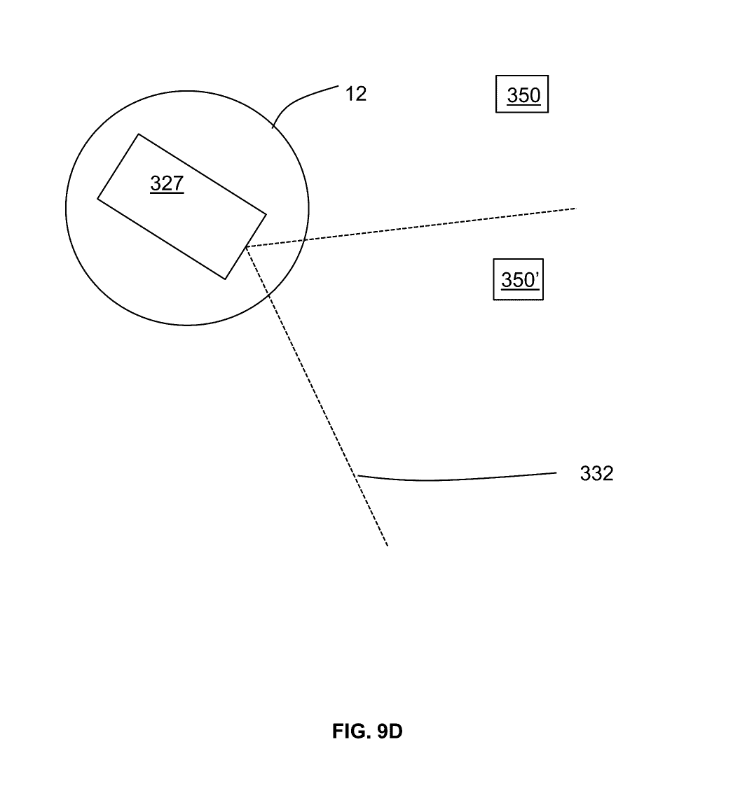

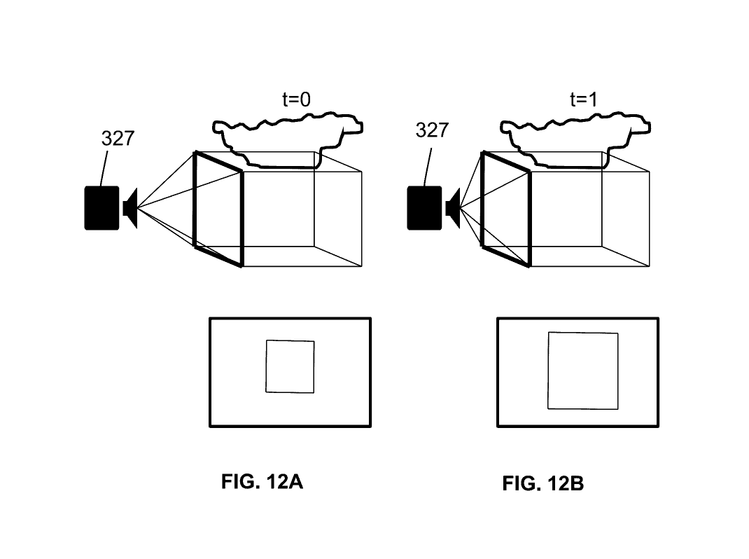

Referring now to FIGS. 9A and 9B and specifically to the operations performed by the processor at blocks 406, 410 and 414 of FIG. 6, FIG. 9A illustrates an idealized image of a tracking marker module 350, comprising at least one illustrative feature 352. The feature(s) 352 may comprise different LEDs, text characters or other items to optionally be included on a tracking marker module. The features provide 2D or 3D structure. In embodiments, the tracking marker module may be an object having a known geometry, and the features may be the geometrical features of the object, as described below in relation to FIGS. 12A to 14B. In embodiments, an idealized image of a tracking marker module may be stored in memory accessible to the processor 330. Alternately, characteristics of the features 353 of a tracking marker module may be stored in memory accessible to the processor 330. The idealized image and features may relate to representations of the tracking marker module, as imaged by a camera system of an HMD, from a known position and orientation relative to the tracking marker module.

At block 406, the processor may detect a tracking marker module 350 by comparing sensor readings provided by the camera to the stored idealized image (or stored characteristics of the features) of the tracking marker module 350, in order to detect the tracking marker module 350 in the sensor readings. The processor may perform known image processing techniques to detect the tracking marker module 350. By way of example, the processor may segment the image and measure features of possible markers in the segmented image to detect a tracking marker module 350.

At block 410, the processor may process sensor readings depicting the tracking marker module to determine the current position and orientation of the tracking marker module 350 relative to the HMD. The processor is configured to determine its relative position and orientation from the tracking marker module by evaluating a variation between a depiction of the tracking marker module 350 in the sensor readings, as compared to the stored idealized image or stored features of the tracking marker module. Specifically, the processor is configured to process the sensor readings in order to determine a relative distance from the HMD to the marker along a Cartesian grid, in order to provide a distance vector to the marker (i.e. capturing both the distance and angle with respect to the HMD's field of view). Further, the processor is configured to determine the marker's relative yaw, pitch and roll. The distance vector and yaw, pitch and roll of the marker may thus be determined by evaluating a variation in measured features of the tracking marker module 350 in the sensor readings as compared to features stored in memory—such as the variation from dimension 353 to dimension 353′ in FIGS. 9A to 9B.

Alternate techniques of determining the relative position and orientation of the tracking marker module 350 are contemplated, such as where the camera system 327 comprises a depth camera, or a stereoscopic camera for directly measuring distance to a marker. If a depth camera or stereoscopic camera is provided, the orientation and relative position of the camera system 327 may be determined, even if no tracking marker module is detected. More particularly, in some embodiments the camera system comprises more than one camera or may comprise a depth camera. Where the camera system comprises two cameras, the cameras may provide stereoscopic 3D vision. A camera system comprising multiple cameras or depth cameras may be configured to determine distances to various obstacles in the environment in order to provide a depth map of the environment. In some embodiments, the camera system 327 comprises a depth camera for markerless tracking. The system is configured to create a depth map based on image frames taken from the depth camera. The depth map can then be used to determine the distances between the HMD and objects. For example, the system may recognize the distance the HMD is away from their surrounding walls and the graphics engine can utilize this information for accurate tracking of position and orientation of the user.

At block 414, the processor performs a reverse transformation on the measured distance vector, and yaw, pitch and roll in order to determine the user's relative position and orientation from the marker 350. This reverse transformation may include reversing the calculated distance vector, and yaw, pitch and roll with respect to at least one axis of symmetry between the HMD and the marker.

In embodiments, the world coordinates of a tracking marker 350 may be stored in memory, such that, when a tracking marker 350 is detected and the relative position and orientation of the tracking marker 350 is determined, the relative position and orientation may be further correlated to a known position and orientation of the tracking marker 350 in the physical environment, so that the position and orientation of the camera system 327 in the world coordinates may be determined.

At block 416, the processor may receive measurements from the IMU, wherein the measurements provide information relating to the current position or orientation of the HMD. If information from the IMU is provided, the processor may integrate the information relating to the HMD's position or orientation with the previously determined position and orientation, in order to provide a more accurate measurement of the HMD's position and orientation.

As described, at block 416, in some embodiments components of an IMU may provide additional measurements relating to position and orientation of the HMD. The information from the IMU may provide information relating to position and orientation for 9 degrees of freedom. As described above, the IMU may incorporate various sensors such as gyroscopes, accelerometers and/or magnetometers. Information from the IMU may provide increased accuracy of the HMD's determined position and orientation throughout multiple scans given that certain components of the IMU may be highly sensitive to changes in the HMD's position and orientation. Further, measurements from the IMU may be more quickly processed than determinations of position and orientation from the IMS, such that measurements from an IMU may be briefly relied upon by the processor for AR applications until the processor determines the position and orientation of the HMD using the IMS, which may be used to correct any inaccuracies introduced as a result of cumulative errors in the IMU measurements.

Where at block 408 the processor does not detect sensor readings providing a depiction of a tracking marker module 350, the processor may perform the steps relating to block 420. At block 420, the processor may detect that an IMU is communicatively linked to the processor 330. If no IMU is so linked, the processor may proceed to execute the steps described in relation to block 418 without providing a determination of the position and orientation of the HMD, or the processor may provide a previously determined position and orientation. If an IMU is connected, the processor may receive therefrom information relating to the current position or orientation of the HMD. By way of example, where an IMU connected to the processor 330 comprises at least one accelerometer, if a position and orientation of the HMD was previously calculated by information from the IMS in a previous scan, the processor may use acceleration readings from the IMU to determine the HMD's current acceleration or velocity. The processor may utilize the HMD's current acceleration and velocity to calculate the HMD's current position and orientation from the HMD's previously calculated position and orientation. Accordingly, if a marker is not detected, but an IMU is connected, the processor may rely on a dead reckoning analysis with measurements from the IMU to determine a current position and orientation of the HMD.

Further, at block 408 if the processor does not detect sensor readings providing a depiction of a tracking marker 350, the processor may attempt to dynamically select a different tracking marker or another type of marker (for which feature characteristics may not be known) in order to determine the relative position and orientation of the HMD during subsequent scans, as described in more detail below.

With regards to block 402, in some embodiments, the camera system is only intermittently activated by the processor. In such embodiments, the camera system may be activated at block 402 by the processor as described above, and may be turned off at block 418. In alternate embodiments, the camera system is continually active, but may be only intermittently or repeatedly called by the processor 330 to provide sensor readings.

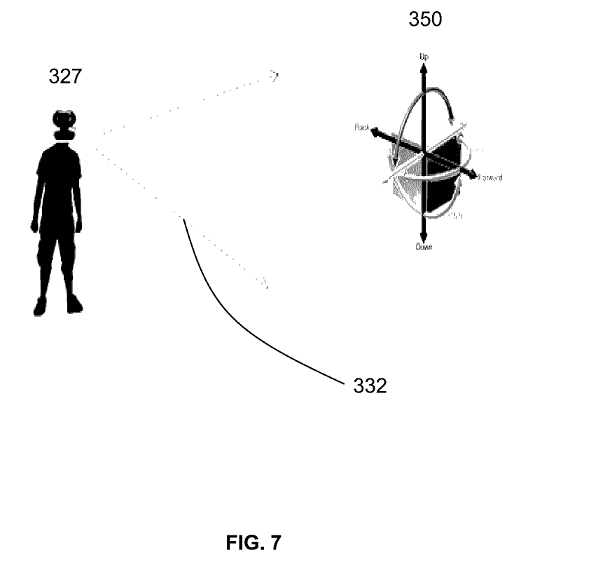

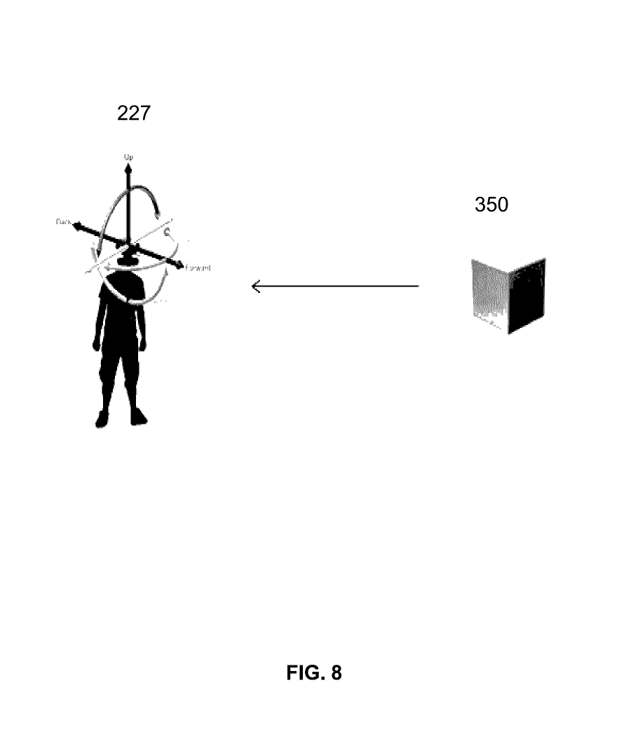

FIG. 6 illustrates the step performed at block 402. Specifically, at block 402 the camera system 327 is activated and is controlled to generate an image depicting its field of view 332. The tracking marker module 350 is shown to be located within the camera system's field of view 332. FIG. 7 illustrates the steps performed at block 410 wherein the processor determines the marker's position and orientation. As illustrated in FIG. 7, in some embodiments the marker's position and orientation can be determined to 6 degrees of freedom. FIG. 8 illustrates the step performed at block 314 wherein the processor performs a reverse transformation of the marker's position and orientation in order to provide the HMD's position and orientation relative to the marker.

Referring now to FIG. 9C, in some embodiments multiple tracking marker modules 350 may be positioned in the environment and detected. In relation to the steps described above in relation to FIG. 5, where multiple markers are used, at block 404 multiple tracking marker modules 350 may be imaged by the camera system in a given scan. At block 408 the processor may detect that multiple tracking marker modules are depicted in sensor readings. At block 410 to 414 the sensor readings may be processed by the processor in order to determine the HMD's position and orientation from the sensor readings relative to each tracking marker module. Further, the determinations of the HMD's position and orientation from the sensor readings relating to each tracking marker module may be collectively processed to provide a more accurate reading of the HMD's position and orientation. By way of example, the determinations of the HMD's position and orientation from the sensor readings relating to each marker may be averaged to provide a more accurate determination of the HMD's position and orientation.

Referring now to FIGS. 9C to 9D, in embodiments where multiple tracking marker modules are positioned in the environment, the markers may be positioned in different positions, such that even if the field of view of the camera system changes (e.g. if the camera system rotates) and one of the markers is no longer in the camera system's field of view, at least one other marker may still be in the field of view. This scenario is depicted in FIGS. 9C and 9D. FIGS. 9C and 9D illustrate the HMD 12 comprising a camera system 327 with a field of view 332. In FIG. 9C, tracking marker modules 350, 350′ are shown to be imaged by the camera system 327. As illustrated in FIG. 9D, if the HMD and camera system 327 rotate, a marker 350′ may remain in the camera system's field of view, while a marker 350 is no longer in the camera system's field of view.

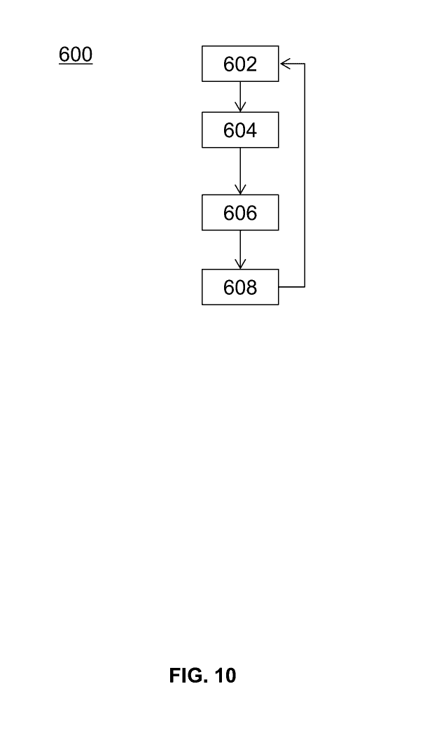

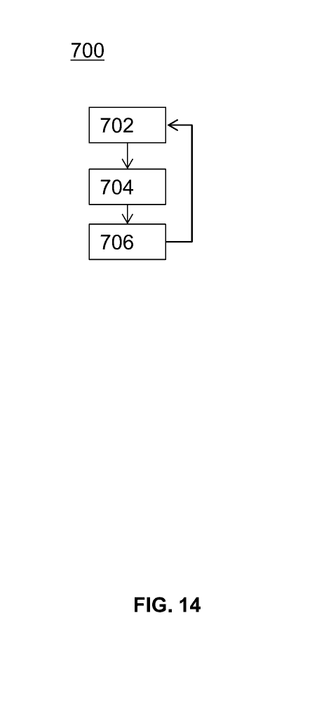

Referring now to FIG. 10, shown therein are blocks 600 relating to steps of a method of tracking changes to the position and orientation of an HMD. In embodiments, the IMS 328 of the present invention may be configured to track changes to its position and orientation and, by extension, to changes to the position and orientation of the HMD, in a physical environment by repeatedly imaging at least one marker and by processing changes in imaged features of the marker in subsequent images thereof. The marker may be a tracking marker module 350, or the marker may be a dynamically selected marker. A dynamically selected marker comprises a marker selected from within the field of view of the IMS, selected according to a method as described in more detail below with regard to FIG. 14.

More particularly, at block 602, at an illustrative time t=0, IMS 328 may provide images of the field of view 332 of a camera system 327 to a processor 330 for processing. At block 604, upon processing the images, the processor 330 detects a tracking marker 350 or a previously dynamically selected marker. If no tracking marker or previously dynamically selected marker is detected, the processor dynamically selects at least one marker. The processor may then store a reference image of the detected or selected marker in accessible memory. At block 606, at a time t=1, the IMS 328 may provide additional images of the field of view 332 of the camera system 327 to the processor for processing. At block 608, if the processor 330 detects the previously detected or dynamically selected marker, the processor may be configured to determine a change to the position and orientation of the IMS 328 (and any associated user 352 or HMD 12) between t=0 and t=1. Specifically, the processor 330 may be configured to process changes between features in a new image of the marker taken at t=1, and features in the stored reference image of the marker taken at t=0, to determine changes to the orientation and position of the HMD between the initial time t=0 and later time t=1. As illustrated, the steps may then be repeated for additional increments of time to continue to track the position and orientation of the HMD.

In various embodiments, in order to track changes to the position and orientation of an HMD, the camera system may comprise a pair of imaging cameras (providing a stereoscopic camera), a depth camera, or an infrared camera.

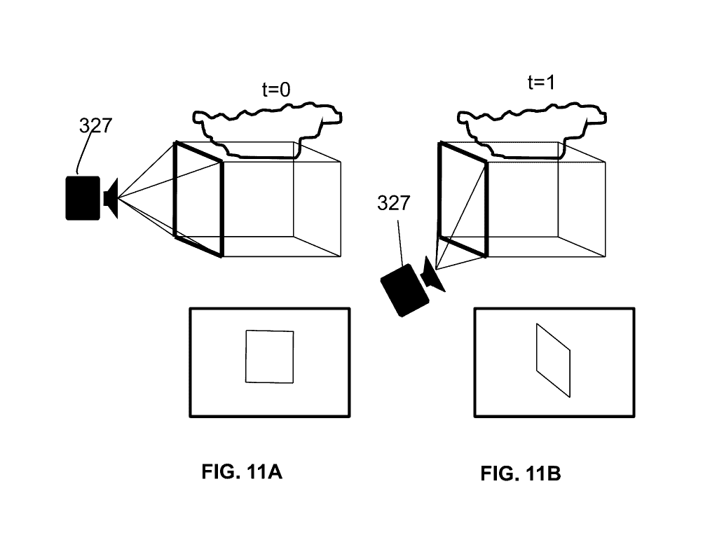

Referring now to FIG. 11A to 13B, shown therein are illustrations of steps performed in tracking changes to the position and orientation of an HMD, as described above in relation to blocks 600. More particularly, FIGS. 11A-13B illustrate the steps performed in dynamically selecting at least one marker, and tracking changes to the position and orientation of an HMD by processing changes to imaged features of the at least one dynamically selected marker. In FIGS. 11A to 13B the dynamically selected markers are illustratively shown to comprise 3D objects from within the environment.

Referring now to FIG. 11A, shown therein is a camera system 327 controlled by a processor to image a tissue box, the camera system 327 being positioned and oriented at a particular position and angle at an initial time t=0. Shown below the tissue box is a rendering of a processed image of the left side of the tissue box, the rendering providing a representation of the tissue box as a series of four joint lines. Joint lines may be edges or curves.

Each of the joint lines can be detected and generated by the processor by applying an edge detection or image segmentation technique, such as the Marr-Hildreth edge detector algorithm or the Canny edge detector operator. The processor further processes the representation of the tissue box with the joint lines to identify the four joint lines as four features in the field of view of the camera. These four features are defined by the processor as one feature set. The feature set may be processed by the processor to determine distinguishing features thereof, such as characteristics of the point at which the four lines intersect as well as the angle of each line intersection. The feature set thus comprises a dynamically selected marker for the camera system. The processor may store a reference image of the marker, or distinguishing features thereof, in memory. Generally, a feature set comprises at least two distinct features.

At a later time t=1 in FIG. 11B, the position of the camera system and the HMD to which it is mounted has now moved. The camera system may move as an HMD comprising the camera system moves through a physical environment. Accordingly, the tissue box is stationary but the camera system now images it from a different angle. Shown below the tissue box is a rendering of the tissue box from the different angle, provided by applying an edge detection or image segmentation to an image of the tissue box, as described above. This rendering provides the same four joint lines, but the joint lines are now measured by the processor to have different angles and the lengths. These four joint lines can be defined again by the processor as one feature set. The processor processes the joint lines and detects that they relate to the dynamically selected marker by comparing the joint lines to the stored reference image. Specifically, the processor detects that the joint lines relate to the same dynamically selected marker by comparing characteristics of the joint lines to characteristics of the reference image. The processor then compares characteristics of the feature set at t=1, such as angles and line lengths of the feature set, with characteristics of the feature set from the reference image stored at t=0. The processor then determines how much the feature set has moved from its position and orientation with respect to the camera system between t=0 and t=1. The processor may then perform a reverse transformation on the movement of position and orientation of the marker, to determine its own change of orientation and position. Accordingly, the processor determines changes to the translation, rotation, and scaling of the marker between t=0 and t=1 in the field of view of the camera mounted on the HMD. The processor then uses the changes to translation, rotation and scaling of the marker to determine changes to its own position and orientation, and that of any associated HMD.

Any determined change to the orientation of the HMD can be compared to measurements from an IMU, if an IMU is communicatively linked to the HMD. Measurements from an IMU can be used to increase accuracy of any change of orientation of the HMD determined with respect to the marker, or to increase processing speeds, as previously described.

It will be understood that in order to determine a change of position and orientation of the camera with respect to the marker, the particular field of view of the camera system capturing the feature set must be known. Accordingly, the processor must be configured to determine the angle and position of the feature set in the field of view of the camera, and further with respect to the HMD.

FIGS. 12A and 12B illustrates imaging of a tissue box, wherein the camera system 327 moves closer to the tissue box between t=0 and t=1, such that the feature sets are shown to have increased lengths between the two images. The increase in length of the feature set can be processed to determine a change to the position of the HMD.

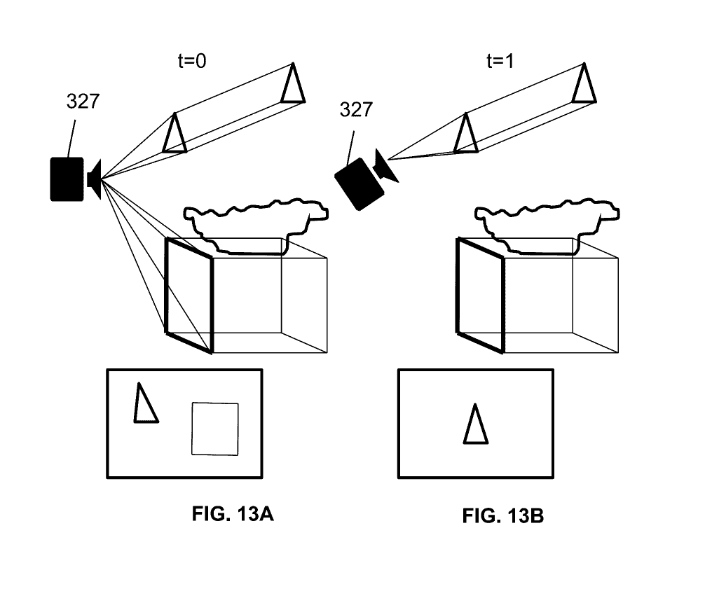

As illustrated in FIGS. 13A and 13B, the processor may detect more than one feature set in the field of view of a camera system 327, and may dynamically select one or more of the feature sets as markers, and capture reference images thereof.

For example, FIG. 13A shows a camera system 327 imaging a tissue box and a three-sided ruler at an initial time t=0. Shown below the tissue box is a rendering of both tissue box and the three-sided ruler, processed by the processor to provide two feature sets having four joint lines and three joint lines, respectively, for a total of seven joint lines. The processor may select the feature sets corresponding to both the tissue box and the three-sided ruler as dynamically selected markers.

As shown in FIG. 13B, at t=1 the camera may move such that the tissue box is no longer in its field of view. Accordingly, the marker relating to the feature set of the tissue box is no longer detected by the processor. The processor may thus determine changes to its position and orientation between t=0 and t=1 with respect to the remaining marker in its field of view, the three-sided ruler.

Referring now to FIG. 14, when dynamically selecting a marker, as at block 604 described above, the system may select a marker according to a hierarchy of markers. Accordingly, processor may store in memory processing instructions relating to a hierarchy of candidate markers and the processor may select a most preferred marker from among candidate markers in the field of view the imaging system.

With regards to the hierarchy of markers, active markers may be generally preferred over passive markers, such as 3D objects.

Some 3D objects may be more preferably selected as markers than other 3D objects. Generally, the more features in a feature set relating to a 3D object, the less reliable the feature set is in determining the position and orientation of the camera system, and accordingly the less preferable the object is as a marker. For example, referring to FIG. 13B, the feature set with three features is preferable over the feature set having four features. Generally, a feature set having a lower order polygon is preferred over a higher order polygon.

A 3D object having a curved feature, or various curved features may be less preferable than a 3D object having straight edges.

Referring now to FIG. 14, shown therein is a method of dynamically selecting a most preferred marker from amongst candidate markers in the field of view of a camera.

At step 702, at a time t=0, the processor processes sensor readings depicting the field of view of a camera system in order to generate a rendering comprising at least one feature set from at least one candidate marker. The processor may apply edge detection, image segmentation and other processing techniques to identify feature sets within sensor readings provided by the camera system. Where types of markers other than 3D markers are used, such as active markers, the processor may apply processing techniques to determine the type of marker imaged in the sensor readings (i.e. infrared, active, etc.). At step 704, the processor processes each of the feature sets according to processing instructions to provide a hierarchy of candidate markers. For example, as described above, an active marker is more preferable than a passive marker (e.g. a 3D object). With respect to 3D objects, feature sets providing a polygon of a lower order are generally preferable to feature sets providing a polygon of a higher order. At step 706, the most preferred marker from the hierarchy of markers is selected as a primary marker. The processor then repeats the steps for t=1 to t=n, and may identify a new most preferred marker if a feature set of is determined to be more preferable than the feature set of the primary marker.

In embodiments, the processor stores a reference image of at least the primary marker for position and orientation tracking as described above. If a new marker is selected as the primary marker, the previous primary marker will be temporarily stored as a secondary marker for performing position and orientation tracking.

In various embodiments, a feature will not be selected as a marker if the processor determined that the feature is moving. Accordingly, the marker selection may be performed by assessing feature sets of candidate markers at time t=0 and t=1, and the processor may determine any feature sets that have changed in a way that indicates that any of the markers is in motion, instead of merely the camera system, such that those candidate markers are not relied upon. The feature set of a marker that is in motion with respect to the HMD may change in a way that is dissimilar to the changes to the feature sets of the other candidate markers in the field of view of a camera system. For example, if the IMU detects no motion between t=0 and t=1, any feature that has changed position between those times will be deemed moving and thus discarded as a candidate marker.

It will be understood that though the steps and methods described in relation to FIG. 10 to FIG. 14 above have been described in relation to 3D object markers, substantially the same steps may be employed to determine changes in position and orientation of the HMD with respect to active markers or IR markers. Accordingly, active markers or IR markers can be detected by the processor or dynamically selected and then used for tracking changes to the HMD's position and orientation as the HMD moves through a physical environment by processing changes to imaged features of the markers. By way of example, the camera system may comprise an IR camera and the processor may be configured to detect or dynamically select an IR marker. IR filtering techniques may applied by the processor to an image of two or more IR markers to determine a feature set of the IR markers at an initial time t=0. Changes to the feature set can then be processed, as described above, to determine changes to the position and orientation of the camera and its associated HMD at T=1.

Although the following has been described with reference to certain specific embodiments, various modifications thereto will be apparent to those skilled in the art without departing from the spirit and scope of the invention as outlined in the appended claims. The entire disclosures of all references recited above are incorporated herein by reference.

We claim:

1. A system for determining the position and orientation of a head mounted display (HMD) for augmented and virtual reality applications, the system comprising:
a) a camera system coupled to the HMD comprising at least one camera for obtaining images in a field of view of the camera system;
b) at least one marker positioned within the field of view of the camera system; and
c) a processor in communication the camera system, the processor configured to:
i) obtain at least one characteristic of the at least one marker, the at least one characteristic corresponding to at least a two dimensional representation of the marker;
ii) obtain the image from the camera system;
iii) detect at least one marker within the image;
iv) upon a marker being detected, determine the position and orientation of the at least one marker relative to the camera system by comparing the orientation of the marker in the image with the at least one characteristic; and
v) perform a reverse transformation on the at least one marker's determined position and orientation to determine the position and orientation of the HMD.

2. The system of claim 1, wherein the camera system comprises at least one depth camera for determining distance between the marker and the HMD.

3. The system of claim 1, wherein the processor is further configured to detect at least two markers.

4. The system of claim 1, wherein the at least one marker comprises an active marker.

5. The system of claim 1, wherein the at least one marker comprises a passive marker.

6. A system for determining the position and orientation of a head mounted display (HMD) for augmented and virtual reality applications, the system comprising:
a) a camera system coupled to the HMD comprising at least one camera for obtaining images in a field of view of the camera system; and
b) a processor in communication the camera system, the processor configured to:
i) obtain, by the camera system, a plurality of images in the field of view of the camera system during movement of the HMD;
ii) define at least one marker common to at least two of the plurality of images;
iii) determine at least one characteristic of the marker corresponding to at least a two dimensional representation of the marker; and
iv) determine the position and orientation of the at least one marker relative to the camera system by comparing the orientation of the marker in a first one of the images with the orientation of the marker in a second one of images based upon a transformation of the at least one characteristic; and
v) perform a reverse transformation on the at least one marker's determined position and orientation to determine the position and orientation of the HMD.

7. The system of claim 6, wherein the processor detects a marker in the plurality of images.

8. The system of claim 6, wherein the processor dynamically selects a marker if no marker is detected in the plurality of images.

9. The system of claim 7, wherein dynamically selecting a marker comprises:
a) rendering at least one feature set of at least one candidate marker, wherein each feature set comprises at least two joint lines representing the at least one candidate marker.
b) processing the at least one rendered feature set according to a predetermined hierarchy to determine a most preferred feature set; and
c) selecting the most preferred feature set as a primary marker.

10. The system of claim 9, wherein according to the hierarchy, candidate markers comprising active markers are preferred over passive markers.

11. The system of claim 9, wherein according to the hierarchy, candidate markers represented by a lower number of joint lines are preferred over candidate markers represented by a greater number of joint lines.

12. A method for determining the position and orientation of a head mounted display (HMD) for augmented and virtual reality applications, the method comprising:
a) obtaining images in a field of view of the camera system coupled to the HMD, at least one of the images capturing at least one marker;
b) obtaining at least one characteristic of the at least one marker, the at least one characteristic corresponding to at least a two dimensional representation of the marker;
c) detecting at least one marker within the image;
d) determining the position and orientation of the at least one marker relative to the camera system by comparing the orientation of the marker in the image with the at least one characteristic; and
e) performing a reverse transformation on the at least one marker's determined position and orientation to determine the position and orientation of the HMD.

13. The method of claim 12, wherein the camera system comprises at least one depth camera for determining distance between the marker and the HMD.

14. The method of claim 12, further comprising detecting at least two markers.

15. The method of claim 12, wherein the at least one marker comprises an active marker.

16. The method of claim 12, wherein the at least one marker comprises a passive marker.

17. A method for determining the position and orientation of a head mounted display (HMD) for augmented and virtual reality applications, the method comprising:
a) obtaining, by camera system coupled to the HMD, a plurality of images in the field of view of the camera system during movement of the HMD;
b) defining at least one marker common to at least two of the plurality of images;
c) determining at least one characteristic of the marker corresponding to at least a two dimensional representation of the marker;
d) determining the position and orientation of the at least one marker relative to the camera system by comparing the orientation of the marker in a first one of the images with the orientation of the marker in a second one of images based upon a transformation of the at least one characteristic; and
e) performing a reverse transformation on the at least one marker's determined position and orientation to determine the position and orientation of the HMD.

18. The method of claim 17, further comprising detecting a marker in the plurality of images.

19. The method of claim 17, further comprising dynamically selecting a marker if no marker is detected in the plurality of images

20. The method of claim 19, wherein dynamically selecting a marker comprises:
a) rendering at least one feature set of at least one candidate marker, wherein each feature set comprises at least two joint lines representing the at least one candidate marker;
b) processing the at least one rendered feature set according to a predetermined hierarchy to determine a most preferred feature set; and
c) selecting the most preferred feature set as a primary marker.

21. The method of claim 20, wherein according to the hierarchy, candidate markers comprising active markers are preferred over passive markers.

22. The method of claim 20, wherein according to the hierarchy, candidate markers represented by a lower number of joint lines are preferred over candidate markers represented by a greater number of joint lines.
